(19) United States
(12) Patent Application Publication
(10) Pub. No.: US 2012/0315384 A1
(43) Pub. Date: Dec. 13, 2012

(54) METHOD OF APPLYING NONCONDUCTIVE CERAMICS ON LITHIUM-ION BATTERY SEPARATORS

(75) Inventors: Mahmoud H. Abd Elhamid, Troy, MI (US); Ion C. Halalay, Grosse Pointe Park, MI (US)

(73) Assignee: GM Global Technology Operations LLC, Detroit, MI (US)

(21) Appl. No.: 13/154,966

(22) Filed: Jun. 7, 2011

(51) Int. Cl. B05D 5/12

(52) U.S. Cl. 427/126.2

(57) ABSTRACT

Methods of coating a nonconductive oxide ceramic on lithium-ion battery separators are provided. A separator is placed in a solution of a volatile organic solvent and an organometallic compound. The separator is coated with a ceramic formed from a metal oxide component of the organometallic compound when the volatile organic solvent evaporates.

### FIELD

The present disclosure relates to methods for applying nonconductive oxide ceramics coatings on lithium-ion battery separators.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The selection of battery materials includes considerations such as the desired power output for and any size limitations of the particular device incorporating the battery. With rechargeable batteries, capacity and rate capability, or the rate at which the battery receives and delivers an electrical charge, are also considered. In electric vehicles or other high-power applications, both the capacity and rate capability are priorities because of the extended range and high charge and discharge rates demanded by these applications.

In lithium-ion batteries, energy is supplied by a diffusion of lithium ions into the battery components as modulated by the separator within the battery. Because automotive applications have varying energy storage and energy power requirements depending on the type of vehicle, the acceleration, and/or power requirements, the rate of diffusion or withdraw of lithium ions varies during operation of the vehicle. This varies the demand load and stress on the separator.

For example, particles removed from the electrodes during the charging and discharging process may cause wear and eventual puncture of the separator. Further, during the high temperature operation of the battery, certain polymeric separators may be impacted by melt shrinkage which may result in short-circuiting between the anode and the cathode. Various compensations have been made to prevent these issues, such as modifying the separator, increasing the thickness of the separator, laborious and expensive coating of the separator, or increasing the size of components of the batteries. However, these and other compensations have shortcomings.

### SUMMARY

This section provides a general summary of the disclosure, and is not a comprehensive disclosure of its full scope or all of its features.

In various embodiments, methods for creating a separator for a lithium-ion battery are provided. A polymeric substrate for the separator is disposed in a volatile solvent. An organometallic compound is mixed with the volatile solvent. The polymeric substrate is coated with a metal oxide component of the organometallic compound.

In other embodiments, one-step coating processes to apply a ceramic coating on a polymeric separator for a lithium-ion battery are provided. The polymeric separator is disposed in a solution of a volatile organic solvent and an organometallic compound. When the volatile organic solvent evaporates from the polymeric separator at room temperature and in less than 1 minute, a reactive metal oxide component of the organometallic compound adheres to the separator.

In still other embodiments, methods for preparing a polymeric separator for a lithium-ion battery are provided. A polymeric substrate for the separator is disposed in a volatile solvent. A metal alkoxide is mixed with the volatile solvent. The volatile solvent is removed by flashing under ambient conditions. The polymeric substrate is coated with a metal oxide component of the metal alkoxide in less than about 10 seconds to provide a coating of from about 1 to about 3 micrometers in thickness.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 depicts a generic battery according to various aspects of the present teachings;

FIG. 2 depicts a scanning electron microscope (SEM) image of a polymeric separator having ceramic materials in the pores according to various aspects of the present teachings;

FIG. 3 depicts a fractured polymeric separator having a ceramic coating according to various aspects of the present teachings; and

FIG. 4 depicts a plurality of ceramic clusters on a polymeric separator according to various aspects of the present teachings.

Corresponding reference numerals indicate corresponding parts throughout the several views of the drawings.

### DETAILED DESCRIPTION

The following description is merely illustrative in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical “or.” It should be understood that steps within a method may be executed in different order without altering the principles of the present disclosure.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Also, as used herein, the terms “first,” “second,” and the like do not denote any order or importance, but rather are used to distinguish one element from another, and the terms “the,” “a,” and “an” do not denote a limitation of quantity, but rather denote the presence of at least one of the referenced items. Furthermore, all ranges disclosed herein are inclusive of the endpoints and independently combinable.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

The present teachings relate to methods of applying nonconductive oxide ceramic coatings on components of lithium-ion batteries. As will be detailed later herein, the nonconductive ceramic provides puncture resistance, adequate tensile strength, dimensional stability, scratch and wear resistance, resistance to thermal shrinkage during operation of the battery, and improved electrolyte wetting and pore filling for improved battery cycling. For clarity, a general description of a generic battery 100 is provided followed by specific information on methods utilized in the present teachings.

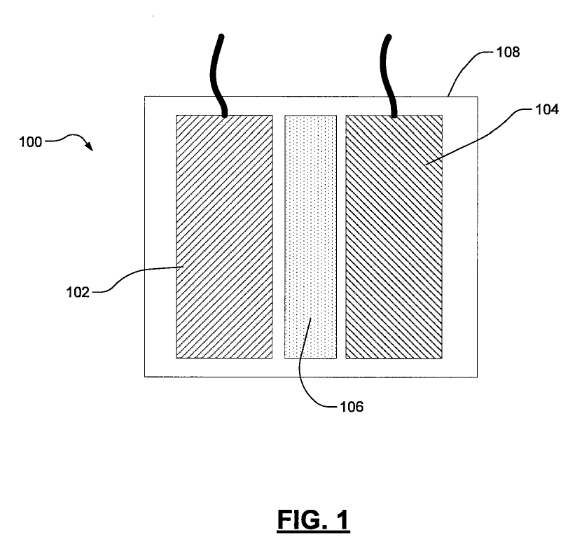

A battery 100 is generically depicted in FIG. 1. The battery 100 includes the anode 102, a cathode 104, a separator 106, and an electrolyte. While the battery 100 of FIG. 1 is a simplified illustration, exemplary battery systems suitable for use in the present teachings include lithium based batteries, silicon based batteries, magnesium based batteries, calcium based batteries, lithium-sulfur systems, and lithium-air systems.

Particularly, the present teachings relate to the separator 106 and methods of preparation. Generally, the separator 106 keeps the anode 102 and the cathode 104 electrically insulated from each other while maintaining ionic conductivity in the battery 100. Thus, the separator 106 is also known as an “insulator.” The separator 106 is a thin porous insulating material that is pervious to ions, displays good mechanical strength, and has long-term stability in the harsh temperature and chemical environment of the battery 100. The separator 106, in various aspects, is dynamic in that it follows the movement of the overall battery 100 or adjacent components within the battery 100, for example any changes during the charge and discharge cycles.

Separators 106 of the present teachings include, but are not limited to, nonwoven materials or porous polymeric films. Where the separator 106 is a nonwoven material, the separator 106 is made from sheet, web, or mat of directionally or randomly oriented fibers that are fixed together by suitable means. The materials include a single polyolefin, or a combination of polyolefins, such as polyethylene (PE), polypropylene (PP), polyamide (PA), poly(tetrafluoroethylene) (PTFE), polyvinylidine fluoride (PVdF), and poly(vinyl chloride) (PVC). With respect to separators 106 made of porous polymeric films, polyolefins are used as the substrate. Exemplary polymers include polyethylene, polypropylene, polymethylpentene, and composites or laminate systems of the same.

Still other separators 106 are within the scope of the present teachings. For example, ion exchange membranes are suitable for use in the instant teachings. These are made from polyethylene, polypropylene or polytetrafluorethylene (PTFE) based materials. Supported liquid membranes are also suitable as the separator 106, and formed of polymers, such as polypropylene, polysulfone, poly(tetrafluoroethylene), and cellulose acetate, and combinations thereof as non-limiting examples. Further, polymer electrolyte membranes (PEM) including polyethylene oxide) or poly(propylene oxide)) are also useful as the separator 106. Solid ion conductors are also employed and are made of inorganic materials that are impervious barriers to gases and liquids. A complete discussion of separators is found in “Battery Separators” by Pankaj Arora and Zhengming Zhang as published at Chem. Rev. 2004, 104, 4419-4462, which is incorporated herein by reference in its entirety.

The demands of the particular battery 100 may require that the separator 106 be responsive in the dynamic system and that it interrupt current circuit in the battery 100 in the event of an accident or excessive heat. However, when the temperature within the battery 100 increases too much, all or parts of the separator 106 may melt, thus blocking proper migration of ions across the separator 106. Should the temperature reach or exceed the melting temperature of the separator 106 materials, the entire separator 106 may melt thus allowing internal short circuiting over a large area. This may lead to destruction of the battery 100. The methods of the present disclosure remedy this and other issues related to protecting separators 106.

The separators 106 are flexible or rigid in various aspects of the present teachings. The thickness of the separators 106 varies based on the size of the battery 100 into which it is being incorporated and the particular application of the battery 100. In select aspects, the separator 106 has a thickness of from greater than about 1 to less than about 100 micrometers, including all sub-ranges.

The porosity of the separator 106 varies according to aspects of the present teachings. In some aspects, the porosity is greater than or equal to 50%, for example from about 50% to 99%, including all sub-ranges. In still other aspects, the porosity is from equal to about 10% to less than or equal to about 50%, including all sub-ranges. It is understood that the porosity refers to the amount of void volume relative to the volume of a substrate of the same shape and size which lacks the voids. The porosity of the separator 106 is uniform in select aspects of the present teachings and is random or non-uniform in other aspects of the present teachings.

In various aspects, the present teachings provide methods for creating a separator 106 for a lithium-ion battery. A general description of the method is provided first, followed by specific information regarding the process. A polymeric substrate for the separator 106 is disposed in a solution of a volatile solvent and an organometallic compound, either by full or partial submersion. The organometallic compound is mixed (fully or partly suspended, dissolved, and/or dispersed) in the volatile solvent. The polymeric substrate is disposed in the volatile solvent. When the solvent flashes or evaporates, a metal oxide component of the organometallic compound is coated on the polymeric substrate of the separator 106.

Suitable volatile solvents include those that have a low boiling point. As used herein, a low boiling point refers to solvents having a boiling point of less than about 150 degrees C. For example, a low boiling point solvent could have a boiling point of about 150 degrees C., 130 degrees C., 80 degrees C., 60 degrees C., 50 degrees C., 35 degrees C., 25 degrees C., and all sub-ranges. In various aspects of the present teachings, the volatile solvent is selected so that the methods detailed herein may be performed at room temperature or slightly above or below room temperature, for example at from about 20 degrees C. to about 35 degrees C. Further, these volatile solvents are non-aqueous according to various aspects of the present teachings.

The volatile solvent is selected so that the methods detailed herein may be performed at ambient pressure. By performing the methods detailed herein at near room temperature, as detailed above, and also at ambient pressure, coating the separators is simplified and the need for expensive equipment to provide the adequate heat and pressure is eliminated. This saves time and the expense, while optimizing the performance of the battery 100 into which the separator 106 is incorporated.

Low-boiling point solvents include, for example, those classified as alkylene halides, alkylketones, alcohols, ethers, ester, and mixtures thereof. Specific examples of suitable solvents include, but are not limited to, hexane and hexane isomers, acetone, benzene, acetonitrile, carbon tetrachloride, cyclohexane, cyclopentane, dichloromethane, diethyl ether, ethanol, ethyl acetate, ethyl ether, ethylene dichloride, methanol, methylene chloride, methyl tert-butyl ether, trichloroethane, pentane, petroleum ether, propanol, tetrahydrofuran, and the like. In various aspects, hexane or a hexane isomer is suitable for the methods of the instant teachings.

Suitable organometallic compounds include metal alkoxides. Exemplary alkoxides include methoxides, ethoxides, propoxides, butoxides, pentoxides, and phenoxides. In various aspects, the organometallic compound is provided in any suitable form, including but not limited to, a block, a liquid, shavings, a powder, and combinations thereof. Shavings or powder are useful in that they provide a greater surface area of exposure to the volatile solvent as compared to a larger block. However, all shapes of the organometallic compound are suitable for use in the present teachings. One skilled in the art appreciates that the combination of the solvent and the particular organometallic compound contributes to the extent of the dissolving or suspension of the organometallic compound.

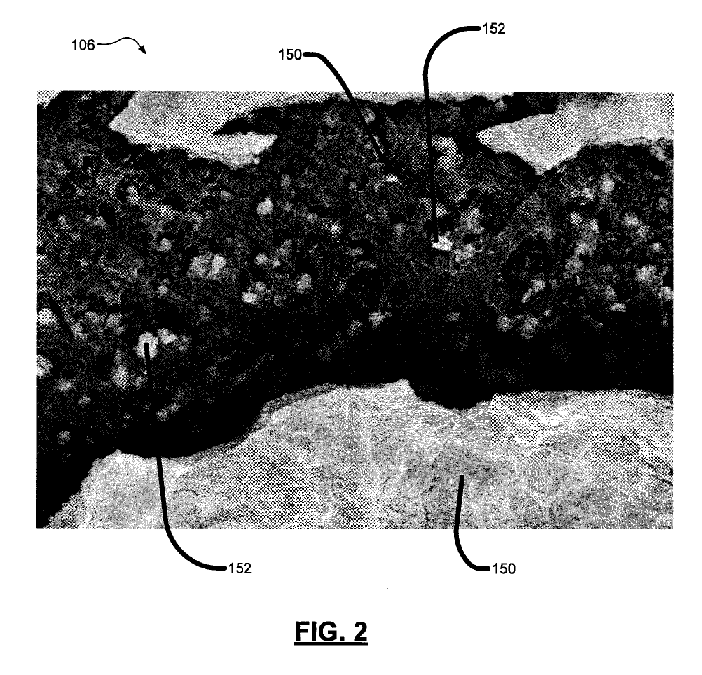

The organometallic compounds are the precursors for the metal oxide component which is coated on the separator 106. With respect to metal alkoxides, the metal alkoxides include an alkyl group attached to the metal oxide component. Exemplary metal oxides include aluminum oxide, zirconium oxide, silicon oxide, calcium oxide, magnesium oxide, titanium oxide, tantalum oxide, and combinations thereof. Other metal oxides are also within the scope of the present teachings. As one example, and with reference to FIGS. 2-4, titanium isopropoxide is used in various aspects as the precursor to provide a ceramic 150 coating made of titanium oxide on the separator 106.

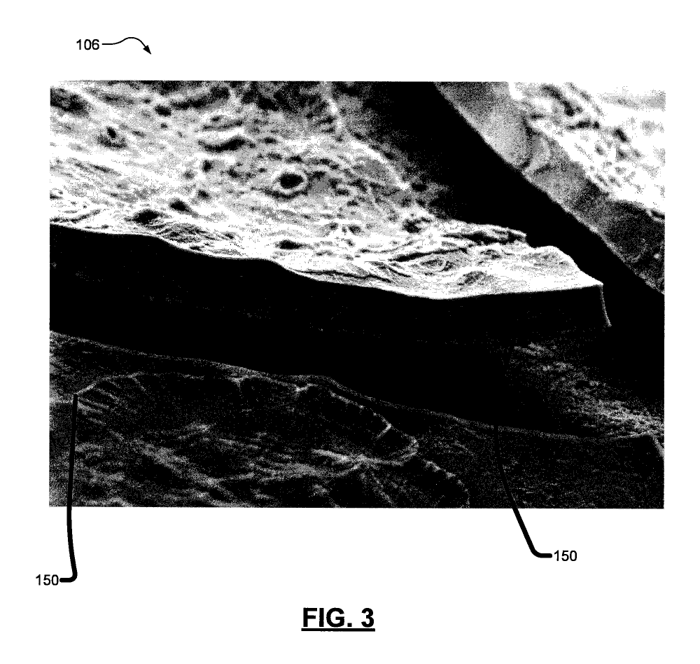

The nonconductive ceramic coating covers the entirety of the separator 106 in various aspects. With reference to FIG. 2, in select features, the nonconductive ceramic 150 particles are applied on a portion of the interior of pores 152 of the separator 106, where the separator 106 is porous or partly porous. In still other features, the nonconductive ceramic 150 is applied as a layer over the separator 106 as shown in FIG. 3. A combination of ceramic 150 in particulate form within the pores 152 and overlaying the separator 106 substrate in layer form is within the scope of the present teachings.

The resultant ceramic 150, whether in particulate or layer form, has a thickness of from greater than or equal to about 0.001 micrometers to less than or equal to about 5 micrometers, including all sub-ranges. In various aspects the thickness of the ceramic 150 is equal to or less than 3 micrometers, including all sub-ranges. The thickness should be selected as to not negatively impact operation of the separator 106 or to cause undesired brittleness of the separator 106. The thickness of the ceramic 150 is modulated as detailed below.

Deposition of the organometallic compound is achieved using a simplified process. In various aspects, the deposition is a one-step process. One-step refers to the coating and removal of the solvent being performed within a time period of less than five minutes and not requiring additional steps to fix the ceramic to the substrate. In such processes, a reactive organometallic compound is dissolved in a low boiling point solvent to make a solution that contains 0.01 to 2 weight percent of the precursor, including all sub-ranges. In various aspects, the solution contains from about 0.001 to 5 weight percentage of the precursor, including all sub-ranges. By varying the concentration of the organometallic compound, the thickness of the ceramic 150 is increased. Further, the thickness of the ceramic 150 is increased by repeatedly exposing the separator 106 to successive treatments with the solution of the volatile solvent and the organometallic compound. It is understood that successive treatments using the one-step process is still considered to be one-step within the scope of the present teachings in that no subsequent processing to fix the ceramic to the substrate is required.

The separator 106 is immersed in the solution or suspension containing the precursor to coat the separator 106 or a region of the separator 106. A thin layer of the reactive organometallic compound that is dissolved or suspended in the non-polar solved is coated on the substrate of the separator 106 in the form of a metal oxide. Because the organometallic compound is dissolved or suspended in the low boiling point solvent, the low boiling point solvent evaporates quickly, leaving the thin reactive organometallic compound to react with air and providing an ordered metal oxide film that adheres to the separator 106. For example, to apply an aluminum oxide to the separator 106, an aluminum alkoxide precursor is dissolved or suspended in the low boiling point solvent. Upon evaporation of the solvent, the precursor is exposed to air and will react with moisture in the air to yield an aluminum oxide film that adheres to the separator 106. This results in the formation of the ceramic 150 coating on the separator 106. The ceramic 150 coating may be continuous across the entire separator 106 or it may be discontinuous. Exemplary discontinuous coatings include evenly, unevenly, or randomly distributed dots, lines, thick stripes or bands, or any other regular geometric or free form shape that is spaced apart from at least one other shape on the separator 106.

The volatile solvent flashes or quickly evaporates such that the metal oxide compound is coated onto the substrate. In various aspects of the present teachings, the flashing occurs in less than 5 minutes, 2 minutes, less than 1 minute, less than 30 seconds, or less than 10 seconds, including all sub-ranges. In still other aspects of the present teachings, the flashing occurs in less than 1 minute. The short flash times allow for the organometallic compound to be coated onto the substrate. The resultant ceramic 150 has a thickness of from about 0.001 micrometers to less than about 5 micrometers, including all sub-ranges.

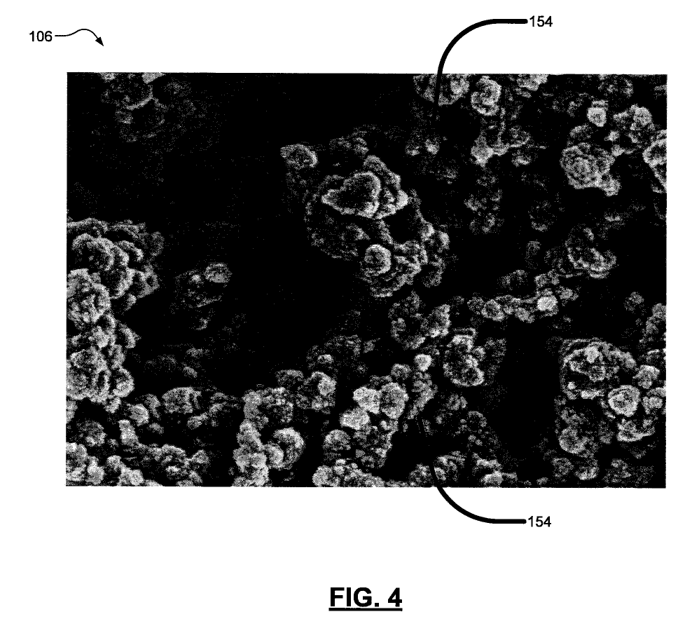

In select aspects, the ceramic layer is a monolayer. In other aspects, a series of layers of the same or different ceramic materials are applied according to the present teachings to form an accumulation of ceramic 150. To achieve the accumulation of the ceramic layer or ceramic materials, the separator 106 is repeatedly and sequentially coated with the selected metal oxide or metal oxides. After application of the first metal oxide, the process is repeated with a subsequent metal oxide to increase the nucleation of the ceramic. This eventually leads to formation of clusters 154 as shown in FIG. 4.

Notably, after the separator 106 is coated with the ceramic 150, no additional preparation steps are required prior to incorporating the polymeric separator 106 into the lithium-ion battery, as a non-limiting example. In other systems, there are additional preparation steps. These additional steps are cumbersome, expensive, and provide an inefficient process.

The present teachings provide efficient and rapid methods to protect the separator 106 and facilitate its prevention of physical contact between the electrodes, while enabling lithium ion transport and preventing electronic conduction. By coating the separators 106 with the nonconductive ceramic oxide according to the instant disclosure, the separators 106 provide adequate mechanical strength (high through-plane puncture resistance and in-plane tensile strength), dimensional stability, and resistance to thermal shrinkage during operation. The ceramic layer is nonconductive and provides the advantages of improved mechanical properties (puncture strength, as well as scratch and wear resistance), improved shrinkage resistance due to robust ceramic frame, and improved electrolyte wetting and pore filling for improved battery cycling.

The ability to immediately incorporate the separator 106 into the battery 100 when it is produced using the methods detailed herein is not available with other known application techniques such as gas phase or vacuum deposition techniques, using high melting point polymers to from the separator, and/or coating the surface of the separator with a ceramic powder as well as organic-inorganic composite materials. By modulating the application of ceramic materials using the present one-step technique, the detriments of adhesion of a ceramic powder to the external surfaces of a separator that are observed in other application methods are mitigated.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

### EXAMPLES

### Example 1

Titanium isopropoxide is dissolved in hexane at room temperature (25 degrees Celsius). The titanium isopropoxide is present in the hexane at a concentration of 0.05 weight percent (by total weight of the solution). A separator 106 is placed in the titanium isopropoxide and hexane. The low boiling point of the hexane (approximately 36 degrees Celsius) causes it to evaporate and leave a thin reactive compound of the titanium isopropoxide to react with humid air to make an adherent, ordered titanium oxide film on the separator 106 when the hexane evaporates after a period of less than ten seconds under ambient temperature and pressure conditions.

FIGS. 2-4 depict a separator 106 prepared according to the method disclosed above. The titanium oxide particles 150 are disposed in the pores 152 of the separator 106 (as best shown in FIG. 2) and also across the surface of the separator 106 (as best shown in FIG. 3). Turning to FIG. 3, the separator 106 surface appears to be coated with a quasi-continuous layer. The titanium oxide ceramic 150 forms the nonconductive and protective ceramic layer on the separator.

FIG. 4 depicts a close-up scanning electron microscope view of a separator 106 prepared according to the methods disclosed above. The process of coating the separator 106 with the titanium isopropoxide is repeated until the ceramic 150 in particulate form creates clusters 154 of varying size due to nucleation. The clusters 154 provide an intricate path through which the lithium migrates while preventing puncturing of the separator 106.

### Example 2

A suspension of the titanium isopropoxide and hexane is prepared such that the titanium isopropoxide is present at 0.1 weight percent (by total weight of the solution). A separator 106 is exposed to the solution and the hexane evaporates as detailed above. The resultant ceramic 150 on the separator 106 has a thickness twice that of the separator 106 prepared in Example 1 due to the increased concentration of the precursor.

### Example 3

Aluminum methoxide is dissolved in hexane at room temperature (25 degrees Celsius). The aluminum methoxide is present in the hexane at a concentration of 1.5 weight percent (by total weight of the solution). A separator 106 is placed in the aluminum methoxide and hexane. The low boiling point of the hexane (approximately 36 degrees Celsius) causes it to evaporate and leave a thin reactive compound of the aluminum methoxide to react with humid air to make an adherent, ordered aluminum oxide film on the separator 106 when the hexane evaporates after a period of less than ten seconds under ambient temperature and pressure conditions.

The process is repeated sequentially four times. The coated separator 106 has a collection of clusters 154 within the pores 152 of the separator 106 and a continuous layer of the ceramic 150 covers the separator 106 due to the build up from the successive coatings.

The separators 106 prepared according to the present teachings and Examples 1-3 have enhanced durability. The separators 106 prevent puncture of the separator 106 caused by particles that ingress the inter-electrode space during the charging and discharging process and also during battery manufacture. The consequences of melt shrinking of the polymeric material in the separator at high temperatures and also prevented hard short-circuiting between the positive and negative electrode are also mitigated with the separators 106 prepared according to the Examples. The ceramic materials provide enhanced wetting due to wicking of the electrolyte from the ceramic 150 across the separator 106 and thus increase throughput during battery manufacture due to decreased time for filling with electrode. Further, the improved wetting enables improved rate capability or faster charging and discharging for the battery.

What is claimed is:

1. A method for creating a separator for a lithium-ion battery comprising:
disposing a polymeric substrate for the separator in a volatile solvent;
mixing an organometallic compound with the volatile solvent; and
coating the polymeric substrate with a metal oxide component of the organometallic compound.

2. The method of claim 1, further comprising removing the volatile solvent by flashing under ambient conditions.

3. The method of claim 1, wherein the coating of the polymeric substrate with the metal oxide component of the organometallic compound takes less than about 1 minute.

4. The method of claim 1, wherein the metal oxide component is highly reactive to facilitate incorporation onto the polymeric substrate.

5. The method claim 1, further comprising coating the polymeric substrate with the metal oxide component to form a ceramic on the polymeric substrate.

6. The method of claim 1, further comprising coating the polymeric substrate with the metal oxide component to provide a discontinuous coating on the polymeric substrate.

7. The method of claim 6, wherein the coating is less than about 2 micrometers in thickness.

8. A one-step coating process to apply a ceramic coating on a polymeric separator for a lithium-ion battery, comprising:
disposing the polymeric separator in a solution of a volatile organic solvent and an organometallic compound where the volatile organic solvent evaporates at room temperature in less than 1 minute and a reactive metal oxide component of the organometallic compound adheres to the separator.

9. The process of claim 8, wherein the volatile organic solvent has a boiling point of less than about 100 degrees Celsius.

10. The process of claim 8, wherein the volatile organic solvent is selected from the group consisting of hydrocarbons having a boiling point of less than about 100 degrees Celsius.

11. The process of claim 8, wherein the volatile organic solvent is hexane.

12. The process of claim 8, wherein the metal oxide component is selected from the group consisting of titanium oxides, tantalum oxides, aluminum oxides, zirconium oxides, silicon oxides, calcium oxides, magnesium oxides, and combinations thereof.

13. The process of claim 8, wherein the organometallic compound is a metal alkoxide.

14. The process of claim 8, wherein the organometallic compound is titanium isopropoxide.

15. The process of claim 8, wherein the solution comprises the volatile organic solvent and from about 0.01% to about 2% by weight of the organometallic compound.

16. The process of claim 8, further comprising forming a discontinuous layer of a ceramic material on the polymeric separator.

17. The process of claim 8, further comprising disposing the ceramic material on pores defined by the polymeric separator.

18. A method for preparing a polymeric separator for a lithium-ion battery comprising:
disposing a polymeric substrate for the separator in a volatile solvent;
mixing a metal alkoxide compound with the volatile solvent;
removing the volatile solvent by flashing under ambient conditions; and
coating the polymeric substrate with a metal oxide component of the metal alkoxide, wherein the coating takes less than about 10 seconds and provides a coating of from about 1 to about 3 micrometers in thickness.

19. The method of claim 18, further comprising applying at least one additional coating of the metal oxide component of the metal alkoxide on the polymeric separator for the lithium-ion battery.

20. The method of claim 18, further comprising incorporating the polymeric separator into the lithium-ion battery without additional preparation steps.
